(19) United States
(12) Patent Application Publication
(10) Pub. No.: US 2009/0128814 A1
(43) Pub. Date: May 21, 2009

(54) Modulated polarizer-based polarimeter, and method for determining the polarization state of an optical signal

(76) Inventor: Bogdan Szafraniec, Sunnyvale, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/986,630

(22) Filed: Nov. 21, 2007

(51) Int. Cl. G01J 4/00

(52) U.S. Cl. 356/364

(57) ABSTRACT

In one embodiment, a polarimeter includes a modulated polarizer, a detector and a processing system. The modulated polarizer is modulated at a modulation frequency and is configured to transmit a portion of an optical signal based on its modulation. The detector is configured to generate a time-varying output signal related to a time-varying power of the transmitted portion of the optical signal. The processing system is configured to i) detect at least three frequency components of the time-varying output signal, and ii) determine the polarization state of the optical signal based on the at least three frequency components.

### BACKGROUND

A polarimeter is an instrument that measures the polarization state (or state of polarization (SOP)) of an optical signal, thereby enabling its user to 1) determine an unknown polarization state of the optical signal, or 2) determine whether the polarization state of the optical signal changes. Also, and by measuring the polarization state of an optical signal that is transmitted through a material, a polarimeter can be used to ascertain various optical properties of the material, such as linear birefringence, circular birefringence, linear dichroism, circular dichroism and scattering.

Most frequently, polarimeters determine a polarization state by estimating the power transmitted through polarizers of different types. See, for example, D. Derickson, Ed., Fiber Optic Test and Measurement, Prentice-Hall (1997). In some cases, measurements from the different types of polarizers are taken sequentially, i.e., after a power measurement is taken for one type of polarizer, the polarizer is reconfigured to another type of polarizer, and another power measurement is taken. Depending on the polarizer, reconfiguration can be accomplished via rotation of an element, or via insertion/removal of one or more optical elements (e.g., waveplates).

Sequential mechanical reconfiguration of a polarizer is inherently slow. As a result, an optical signal is often split into multiple signals, with each of the signals being simultaneously transmitted through a polarizer of a different type. However, while increasing measurement speed, the use of multiple polarizers is more complex and more expensive. Furthermore, the multiple optical channels of a parallel implementation need to be properly calibrated to provide accurate measurements.

### BRIEF DESCRIPTION OF THE DRAWINGS

Illustrative embodiments of the invention are illustrated in the drawings, in which:

FIG. 1 illustrates a first exemplary embodiment of a polarimeter;

FIG. 2 illustrates a first exemplary embodiment of the modulated polarizer shown in FIG. 1;

FIG. 3 illustrates the Poincare sphere and the Stokes vector that define a polarization state;

FIG. 4 illustrates the Poincare sphere, exemplary Stokes vectors which represent a modulated polarizer and the polarization state of an optical signal, and an angle, a, between two of the vectors;

FIG. 5 is a perspective view of a second exemplary embodiment of the modulated polarizer shown in FIG. 1;

FIG. 6 illustrates a cross-section of the polarization controller shown in FIG. 5;

FIG. 7 illustrates a second exemplary embodiment of a polarimeter;

FIG. 8 illustrates a first exemplary trajectory of the modulated polarizer shown in FIGS. 1 and 5, and FIG. 9 illustrates the components of the Stokes vector that describes the exemplary trajectory shown in FIG. 8;

FIG. 10 illustrates a second exemplary trajectory of the modulated polarizer shown in FIGS. 1 and 5, and

FIGS. 11-13 illustrate the Stokes components that describe the modulated polarizer; and

FIG. 14 illustrates exemplary voltage waveforms that may be applied to the polarization controller shown in FIG. 5 to produce the exemplary trajectory shown in FIG. 10.

### DETAILED DESCRIPTION

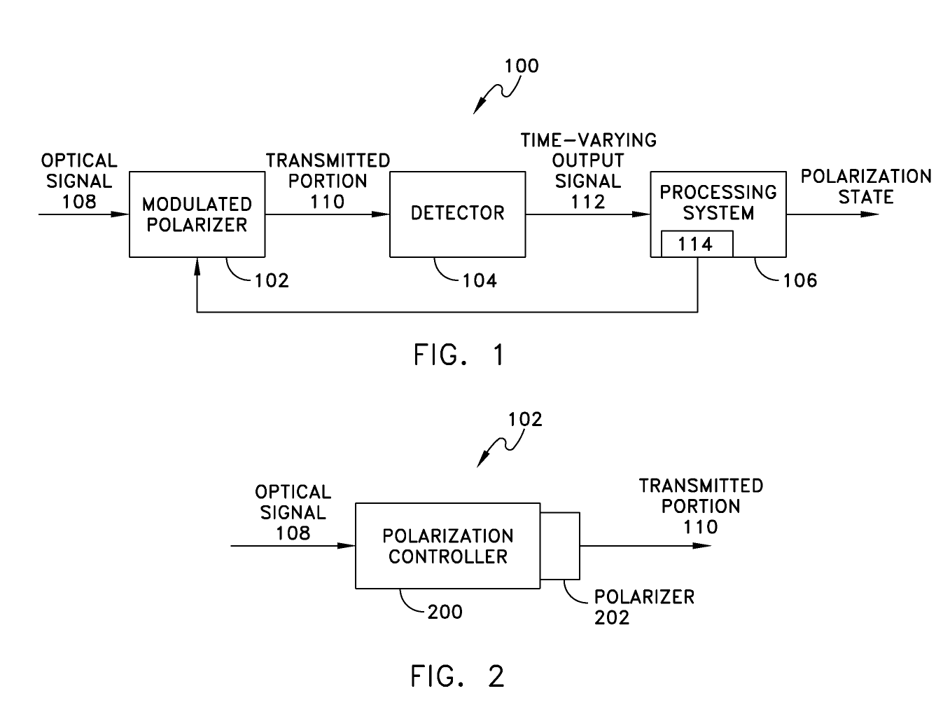

FIG. 1 illustrates a first exemplary embodiment of a polarimeter 100. The polarimeter 100 comprises a modulated polarizer 102, a detector 104 and a processing system 106. In general, and as will be described more fully later in this description, the modulated polarizer 102 is modulated at a modulation frequency and is configured to transmit a portion 110 of an optical signal 108 based on its (i.e., the modulated polarizer's) modulation. The detector 104 is configured to generate a time-varying output signal 112 related to a time-varying power of the transmitted portion 110 of the optical signal 108. The processing system 106 is configured to 1) detect at least three frequency components of the time-varying output signal 112, and 2) determine the polarization state of the optical signal 108 based on the at least three frequency components.

Having provided a brief overview of the components and operation of the polarimeter 100, each of its components will now be described in detail, beginning with the modulated polarizer 102.

As mentioned above, a modulated polarizer 102 is modulated at a modulation frequency and is configured to transmit a portion 110 of an optical signal 108 based on its (i.e., the modulated polarizer's) modulation. From one perspective, the modulated polarizer 102 can be thought of as a polarizer whose type is modulated. From another perspective, the modulated polarizer 102 can be thought of as a polarizer that alters, at one or more modulation frequencies, an alignment between 1) a vector that represents the input polarization state of an optical signal 108, and 2) a vector that represents the modulated polarizer 102. The alignment of the vectors is altered by modulating the orientation of the vector that represents the modulated polarizer 102. As the alignment of the vectors is altered, the modulated polarizer 102 transmits a portion 110 of the optical signal 108 based on the altered alignment.

As described in the preceding paragraph, the modulated polarizer 102 and the input polarization state of the optical signal 108 can both be represented by vectors, however, for simplicity the term “vector” will often be omitted in this description.

In one embodiment, and as shown in FIG. 2, the modulated polarizer 102 may be realized from a polarization controller 200 and a polarizer 202. The polarizer 202 is optically downstream from the polarization controller 200 and has a fixed orientation with respect to the polarization controller 200. In operation, the polarization controller 200 alters the alignment between the input polarization state of the optical signal 108 and the polarizer 202, at one or more modulation frequencies. This operation can alternately be viewed as modulation of a polarizer, or as modulation of the polarization state of the optical signal 108. Both concepts are equivalent and can be used interchangeably. However, the concept that is often simpler is the concept of modulating a polarizer.

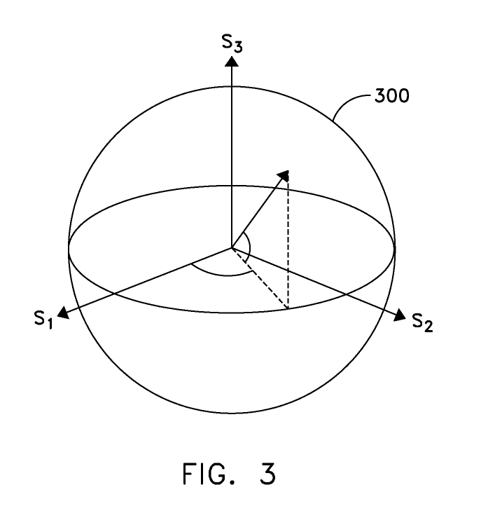

As the alignment between the modulated polarizer 102 and the input polarization state of the optical signal 108 is altered, the portion 110 of the optical signal 108 that is transmitted by the polarizer 202 is altered as well. That is, when the polarization controller 200 alters the modulated polarizer 102 such that its type is aligned with the input polarization state of the optical signal 108, all of the optical signal 108 (ideally) is transmitted by the polarizer 202. However, when the polarization controller 200 alters the modulated polarizer 102 such that its type is orthogonal to the input polarization state of the optical signal 108, none of the optical signal 108 (ideally) is transmitted by the polarizer 202. The orthogonality of the polarizer and the input polarization state corresponds, in the vector space of FIG. 3, to two vectors that point in opposite directions. If the vectors that represent the modulated polarizer 102 and the input polarization state of the optical signal 108 are neither aligned nor opposite, only a fractional portion of the optical signal 108 is transmitted by the polarizer 202. As used in the rest of this description and the appended claims, transmission of a “portion” 110 of the optical signal 108 includes transmission of all, none, or a fractional portion of the optical signal 108 (as determined by an altered alignment between a modulated polarizer 102 and the input polarization state of the optical signal 108).

Preferably, the polarization controller 200 alters the optical signal 108 in a continuous manner, and without substantially altering the power (or intensity) of the optical signal 108. Specifically, and considering for a moment an optical signal that propagates through the modulated polarizer 102 in the reversed direction, the modulation of the polarizer 102 is uniquely described by a transformation of the polarization state of an optical signal that passes through the polarizer 202 and into the polarization controller 200 in the reversed direction. The new polarization state is defined by the polarization controller 200. By reciprocity only that new polarization state is fully transmitted through the polarizer 202 when an optical signal propagates through the modulated polarizer 102 in the forward direction. Thus, by examining that transformation, we can precisely determine the polarizer modulation.

The polarization state of an optical signal, as well as a polarizer type, can be described in terms of Stokes vectors. The Stokes vector has four components, S₀-S₃. The first component, S₀, is the intensity of the optical signal, and the remaining three components describe the polarization state of the optical signal. The polarization state of the optical signal is represented as a vector in a three dimensional space, in which the three axes can be viewed as representing the content of different types of polarized light found in the optical signal.

Refer now to FIG. 3, which illustrates the three dimensional space in which the Stokes vector is defined. The S₁ axis measures the content of linear polarization, with the positive values corresponding to horizontally polarized light and the negative values corresponding to vertically polarized light. The S₂ axis measures the content of linear polarization at 45 degrees to the horizontally (or vertically) polarized light, with the positive values corresponding to +45 degree polarized light and the negative values corresponding to −45 degree polarized light. Finally, the S₃ axis measures the content of circular polarization, with the positive values representing right-hand circularly (right circular) polarized light and the negative values representing left-hand circularly (left circular) polarized light. A normalized Stokes vector has all of its components normalized with respect to its first component. Thus, a normalized Stokes vector has a normalized intensity equal to one. For a monochromatic optical signal, the possible polarization states of the optical signal lie on a unit radius sphere 300 that is often referred to as the Poincare sphere.

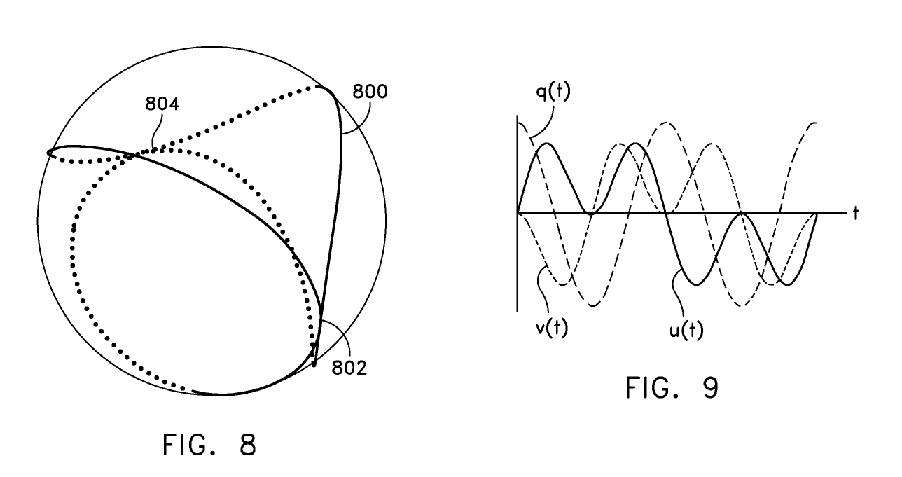

In the context of the polarization space shown in FIG. 3, the polarization controller 200 (FIG. 2) transforms the polarizer 202 into a new effective polarizer. That is, the polarization controller 200 modulates the polarizer 102 through different polarizer types. By way of example, the modulated polarizer 102 could be represented by a trajectory 800 of a time-varying Stokes vector on the Poincare sphere, as shown in FIG. 8. The precise trajectory traced by the time-varying Stokes vector is determined by 1) the polarizer 202, and 2) the modulation of the polarization controller 200.

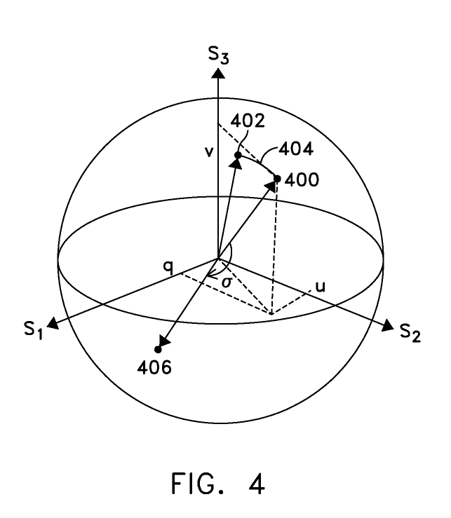

Refer now to FIG. 4, which shows a perspective view of the Poincare sphere. Consider a point 400 on the Poincare sphere. Point 400 belongs to a section of a polarizer trajectory 404 produced by the polarization controller 200. The normalized Stokes vector that ends at this point has three components along the three axes of the Stokes vector space. The components are obtained by projecting the Stokes vector onto the axes S₁, S₂ and S₃. The three projections are shown as q, u, and v. As the Stokes vector that describes the polarizer 102 moves to a point 402 on the trajectory 404, the Stokes vector components increase and decrease depending on the particular location of the point 402.

For the purposes of this discussion, it will be assumed that q(t), u(t), and v(t) are periodic functions that define the movement of a time-varying (i.e., modulated) polarizer, P(t), along a particular trajectory. This will be the case if a desired trajectory on the Poincare sphere is a closed loop, and if each modulation cycle of the polarization controller 200 results in the polarizer 102 moving once around the loop. As will be discussed in more detail below, the movement of a time-varying polarizer can also be defined by periodic functions that trace an open path (i.e., not a closed loop) on the Poincare sphere. It should be noted, however, that while q(t), u(t), and v(t) are periodic, q(t), u(t), and v(t) cannot each be pure tones simultaneously. For the components to be pure tones, there must be three modulation frequencies, ω_{q}, ωᵤ, and ωᵥ, for which

q(t)=cos(ω_{q}t)

u(t)=cos(ωᵤt+Dᵤ)

v(t)=cos(ωᵥt+Dᵥ)

q(t)²+u(t)²+v(t)²=1 (1)

where Dᵤ and Dᵥ are fixed phase shifts. It can be shown that this system of equations has no solutions.

While a solution in which each of the components is a single tone cannot be found, a solution that only depends on three tones is possible. For example,

q(t)=cos(2ωt)

u(t)=(sin(ωt)+sin(3ωt))/2

v(t)=(−cos(ωt)+cos(3ωt))/2 (2)

The above equations satisfy the constraint q(t)²+u(t)²+v(t)²=1 and describe a trajectory that produces only three tones.

A more detailed discussion of the considerations that go into choosing a particular trajectory on the Poincare sphere is provided below. However, for the purposes of the present discussion, it will simply be assumed that the polarizer 102 has a predetermined trajectory on the Poincare sphere.

Now consider a polarizer 102 described by the normalized Stokes vector, P, where

$$P = ( \begin{matrix}q ( t ) \\ u ( t ) \\ v ( t )\end{matrix} ) , \qquad ( 3 )$$

and where the first component of the Stokes vector (i.e., intensity) is omitted for simplicity. In this description, a polarizer 102 fully transmits the optical signal having a polarization state that is described by the same Stokes vector P (aligned vectors) and fully rejects an optical signal whose polarization state is described by the vector −P that points in an opposite direction.

If the Stokes vector that describes a polarizer modulation executes a closed loop on the Poincare sphere, at an angular frequency, ω, then each polarization dependent component can be expanded in a Fourier series with ω as the fundamental frequency. The number of significant harmonics in the series depends on the details of the trajectory on the Poincare sphere. For example, the trajectory described by Eq. (2) has only three significant harmonics. In the more general case, the components of the Stokes vector can be written in the following form:

q(t)=q₀+A_{1,1} sin(ωt+φ_{1,1})+A_{1,2} sin(2ωt+φ_{1,2})+A_{1,3} sin(3ωt+φ_{1,3})

u(t)=u₀+A_{2,1} sin(ωt+φ_{2,1})+A_{2,2} sin(2ωt+φ_{2,2})+A_{2,3} sin(3ωt+φ_{2,3})

v(t)=v₀+A_{3,1} sin(ωt+φ_{3,1})+A_{3,2} sin(2ωt+φ_{3,2})+A_{3,3} sin(3ωt+φ_{3,3}) (4)

The constants Aᵢⱼⱼ and φ_{i,j}, where i=1 to 3 and j=1 to N, represent amplitudes and phases of individual harmonics. The constants q₀, u₀, and v₀ represent the unmodulated part of each Stokes component (the 0^{th} harmonic). As will become clear from the following discussion, the number of harmonics that are significant, N, must be at least 3. This excludes some solutions like solutions when a polarization controller behaves like a rotating waveplate generating only two harmonics.

Alternatively, using a complex notation, Eq. (4) can be rewritten in the following form:

q(t)=q₀+q₁ exp(jωt)+q₂ exp(j2ωt)+q₃ exp(j3ωt)+

u(t)=u₀+u₁ exp(jωt)+u₂ exp(j2ωt)+u₃ exp(j3ωt)+

v(t)=v₀+v₁ exp(jωt)+v₂ exp(j2ωt)+v₃ exp(j3ωt)+ (5)

where qₘ=A_{1,m} exp(jφ_{1,m}), uₘ=A_{2,m} exp(jφ_{2,m}), and vₘ=A_{3,m} exp(jφ_{3,m}), and where j=\sqrt{−1} is an imaginary number.

The above equation simply implies that periodic functions can be expressed as sums of harmonics. Conceptually, this property is captured by the following symbolic equation:

$$P = ( \begin{matrix}q ( t ) \\ u ( t ) \\ v ( t )\end{matrix} ) = ( \begin{matrix}{q}_{0} + {q}_{1} + {q}_{2} + {q}_{3} + … \\ {u}_{0} + {u}_{1} + {u}_{2} + {u}_{3} + … \\ {v}_{0} + {v}_{1} + {v}_{2} + {v}_{3} + …\end{matrix} ) , \qquad ( 6 )$$

where the subscripts denote the number of the harmonic. The exponential terms that represent the frequencies have been omitted for simplicity of notation. It is important to note that the harmonics qᵢ, uᵢ and vᵢ are complex numbers.

The above-described modulations all involve expanding the polarization dependent components of the normalized Stokes vector, P, that describes the modulated polarizer 102 in a harmonic series. That is, each component is expanded in terms of a number of component frequencies, in which the component frequencies are integer multiples of some fundamental frequency. However, as will be discussed in detail below, there are cases in which the polarization dependent components of the modulated polarizer 102 can be expanded in a series in which the frequencies are not integer multiples of a predetermined frequency. Hence, in the general case, it will be assumed that:

q(t)=C₁+A_{1,1} sin(ω₁t+φ_{1,1})+A_{1,2} sin(ω₂t+φ_{1,2})+A_{1,3} sin(ω₃t+φ_{1,3})

u(t)=C₁+A_{2,1} sin(ω₁t+φ_{2,1})+A_{2,2} sin(ω₂t+φ_{2,2})+A_{2,3} sin(ω₃t+φ_{2,3})

v(t)=C₁+A_{3,1} sin(ω₁t+φ_{3,1})+A_{3,2} sin(ω₂t+φ_{3,2})+A_{3,3} sin(ω₃t+φ_{3,3}) (7)

As will become clear from the following discussion, there must be at least three frequencies ωⱼ. In the case of a harmonic expansion, ωⱼ=j*ω, where ω is the fundamental frequency.

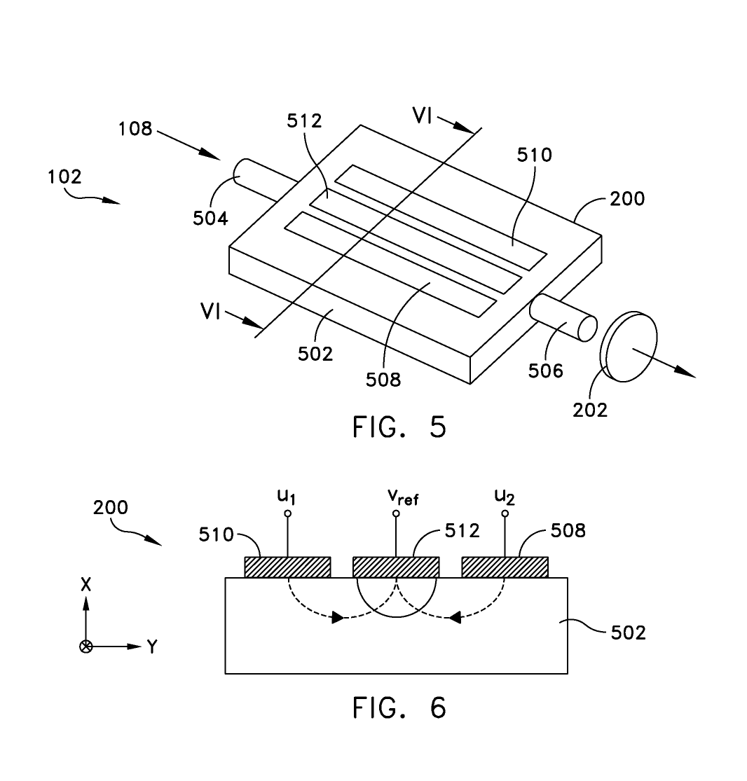

Refer now to FIGS. 5 and 6, which illustrate another exemplary embodiment of the modulated polarizer 102, including the polarization controller 200 and the polarizer 202. FIG. 5 is a perspective view of the polarization controller 200 and polarizer 202, and FIG. 6 illustrates a cross-section of the polarization controller 200 along line VI-VI of FIG. 5. The polarization controller 200 is constructed from an x-cut, z-propagating, lithium niobate (LiNbO₃) crystal 502, in which an optical signal enters through port 504, perpendicular to the face of the xy plane, and propagates in the z-direction. A surface of the crystal 502 has a plurality of electrodes thereon (e.g., three electrodes 508, 510, 512). The electrodes 508, 510, 512 are used to apply potentials (voltages) to the crystal 502. The potentials are based on one or more modulation frequencies, and application of the potentials to the electrodes 508, 510, 512 generates modulated electric fields in the crystal 502. The modulated electric fields give rise to a modulated birefringence in the crystal that modifies the polarizer 202 that is optically downstream from the polarization controller 200, and forming the modulated polarizer 102 (as shown in FIG. 2).

The manner in which the potentials applied to the crystal 502 are chosen will be explained in more detail below. However, for the present discussion, it is sufficient to note that a first periodic waveform is applied between electrodes 512 and 510, and a second periodic waveform is applied between electrodes 512 and 508. Electrode 512 is a reference (ground) electrode. In general, the waveforms have the same period. By correctly choosing the potentials that are applied to the crystal 502, the effective polarizer 102 can be altered to produce a polarizer described by a time-varying Stokes vector, which time-varying Stokes vector traces a predetermined trajectory on the Poincare sphere, as previously discussed. The potentials applied to the crystal 502 may be chosen such that the trajectory will have its center of gravity at the center of the Poincare sphere.

Now consider the propagation of an optical signal through the modulated polarizer 102 (FIG. 5) in the reverse direction. The signal entering the polarization controller 200 in the reverse direction, through port 506, must take the polarization state that is enforced by the polarizer 202. That polarization state is then altered by the polarization controller 200. As a consequence, and at the input port 504, an optical signal takes a new polarization state, P(t), that may change in time depending on the voltages applied to the polarization controller 200. Due to reciprocity, the new polarization state P(t) uniquely defines the type of the modulated polarizer 102 when an optical signal propagates through the modulated polarizer 102 in the forward direction, as only this polarization state will be transmitted by the polarizer 202 unattenuated. Thus, the Stokes vector, P(t), that represents the modulated polarizer 102, can trace a predetermined trajectory on the Poincare sphere by a proper selection of control voltages applied to the polarization controller 200. The predetermined trajectory may be defined by Eqs. (3) and (6).

Having described an exemplary embodiment and operation of the modulated polarizer 102, reference is again made to the polarimeter 100 (FIG. 1). An optical signal 108 entering the modulated polarizer 102 may be described by the Stokes vector (i, x, y, z). Consider the optical signal 108 to have the Stokes vector

$$S = ( \begin{matrix}x \\ y \\ z\end{matrix} ) , \qquad ( 8 )$$

where the first component of the Stokes vector (i.e., intensity) is omitted for simplicity.

The modulated polarizer 102 transmits a time-varying portion 1 10 of the optical signal 108 based on an alignment between the modulated polarizer 102 and the optical signal's polarization state. For an instantaneous state of the modulated polarizer 102, the angle between the Stokes vector of the optical signal 108 and the instantaneous state of the modulated polarizer 102, as viewed on the Poincare sphere, is equal to σ. By way of example, FIG. 4 illustrates an angle σ between 1) the Stokes vector of an exemplary polarization state 406 of the optical signal 108, and 2) the exemplary instantaneous state 400 of the modulated polarizer 102.

Given the angle σ, the fractional power, f, of the transmitted portion 110 of the optical signal 108, as seen by the detector 104, is:

$$f = \frac{1}{2} + \frac{1}{2} cos ( σ ) . \qquad ( 9 )$$

Alternately, the power, p(t), seen by the detector 104 can be described by the equation:

$$p ( t ) = \frac{1}{2} i + \frac{1}{2} ( xq ( t ) + yu ( t ) + zv ( t ) ) , \qquad ( 10 )$$

where the fraction ½ is further multiplied by the intensity of the optical signal 108 (FIG. 1), i, and where cos(σ) is found from the dot product of the vectors defined in Eqs. (3) and (8).

The detector 104 (e.g., a photodetector) generates a time-varying output signal 112 that is related to the power, p(t). The processing system 106 detects frequency components of the time-varying output signal 112. The detected frequency components correspond to frequency components of the signals that define (or control) the modulated polarizer 102. Thus, the harmonics of p(t) correspond to the harmonics of q(t), u(t), and v(t) that define the modulated polarizer. In particular, the first three harmonics (p₁, p₂, p₃) detected by the processing system 106 can be described by the equation:

$$2 ( \begin{matrix}{p}_{1} \\ {p}_{2} \\ {p}_{3}\end{matrix} ) = ( \begin{matrix}{q}_{1} & {u}_{1} & {v}_{1} \\ {q}_{2} & {u}_{2} & {v}_{2} \\ {q}_{3} & {u}_{3} & {v}_{3}\end{matrix} ) ( \begin{matrix}x \\ y \\ z\end{matrix} ) , \qquad ( 11 )$$

where qₘ, uₘ and vₘ are the m-th harmonics of q(t), u(t) and v(t) (see Eq. (6)). Eq. (11) shows that the polarization state (x, y, z) of the optical signal 108 can be found by detecting the harmonics p₁, p₂, and p₃ in the time-varying signal 112 generated by the detector 104. Harmonics p₁, p₂, and p₃ may be detected in a synchronous demodulation process utilizing a vector spectrum analyzer or a lock-in amplifier implemented in software or hardware. It is assumed here that the trajectory of the modulated polarizer is known an described by the modulation matrix containing harmonics qᵢ, uᵢ and vᵢ. In order for the solution to exist the determinant of the modulation matrix must be non-zero. It is important to note that the reference phase of the phase sensitive detection process has to be properly chosen in order to provide a real solution for the polarization state (x, y, z). This can be accomplished by testing various reference phases and selecting the one that provides real solutions.

The above-described embodiment of the processing system 106 only detects three harmonics in the signal 112 generated by the detector 104, even in those cases in which the harmonic expansion of the modulated polarizer Stokes vector P (see Eq.(6)) includes additional harmonics or other frequencies. However, embodiments in which more of the components are utilized to provide an over-determined system in which noise is further reduced could be constructed.

The final Stokes vector component that needs to be determined is the intensity, i, of the optical signal 108. Based on Eq. (10), the intensity, i, can be found as the DC component of the time-varying signal 112 generated by the detector 104, under the assumption that q₀=u₀=v₀=0. This assumes that, on average, the modulated polarizer 102 does not favor any polarization component, and that the trajectory of the modulated polarizer 102 is balanced, having a center of gravity in the center of the Poincare sphere. From Eq. (10), and for q₀=u₀=v₀=0,

2p₀=i, (12)

where p₀ is the DC component of the signal 112 generated by the detector 104. Thus, the DC component of the detector's signal 112 is proportional to the intensity of the optical signal 108, and in some embodiments of the polarimeter 100, the processing system 106 can be configured to determine the intensity i based on Eq. (12).

In some cases, the processing system 106 may be configured to determine a degree of polarization (DOP) of the optical signal 108. The DOP of the optical signal 108 may be determined from the Stokes vector of the optical signal 108 as follows:

$$DOP = \frac{\sqrt{{x}^{2} + {y}^{2} + {z}^{2}}}{i} \qquad ( 13 )$$

Of note, Eq. (11) illustrates how to calibrate the polarimeter 100 (FIG. 1). That is, if the harmonics qₘ, uₘ, and vₘ are unknown, but the polarization state of the optical signal 108 is known and controlled, then, by measuring harmonics of the time-varying signal 112 generated by the detector 104 for three known polarization states of the optical signal 108, the harmonics qₘ, uₘ, and vₘ can be found. This is illustrated by the following equation derived from the Eq. (11):

$$2 ( \begin{matrix}{p}_{1 m} \\ {p}_{2 m} \\ {p}_{3 m}\end{matrix} ) = ( \begin{matrix}{x}_{1} & {y}_{1} & {z}_{1} \\ {x}_{2} & {y}_{2} & {z}_{2} \\ {x}_{3} & {y}_{3} & {z}_{3}\end{matrix} ) ( \begin{matrix}{q}_{m} \\ {u}_{m} \\ {v}_{m}\end{matrix} ) , \qquad ( 14 )$$

where (xₙ, yₙ, zₙ) denotes the n-th polarization state of the optical signal 108, pₙₘ denotes the m-th harmonic of the signal 112 detected for the n-th input polarization state, and qₘ, uₘ, and vₘ denote the sought harmonics that describe the modulation of the modulated polarizer 102. The above applies to all harmonics m, thus, it determines the trajectory of the modulated polarizer 102.

The optical signal 108 used to calibrate the polarimeter 100 may, in some cases, be provided by a polarized laser light source. However, other light sources, such as light emitting diode (LED) light sources, can also be used. If the light source does not provide light with a constant fixed polarization, a polarization filter can be introduced between the light source and the modulated polarizer 102.

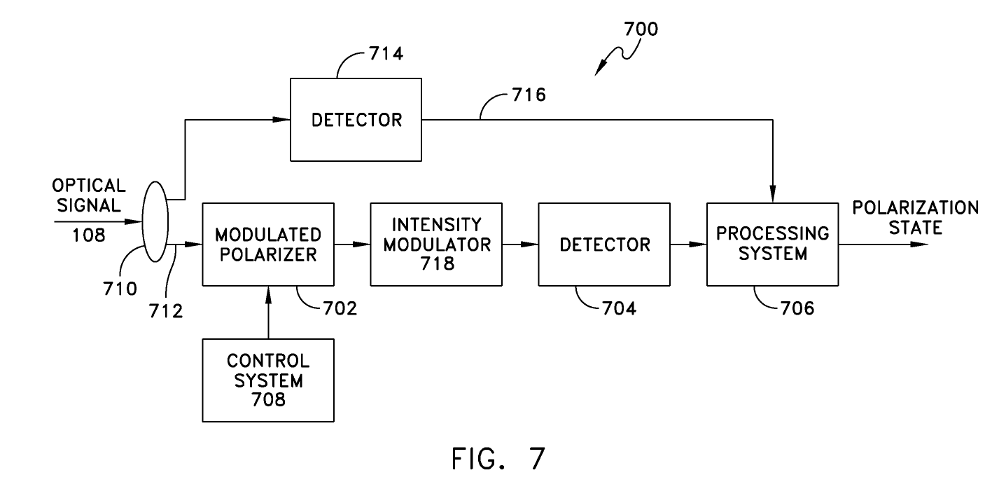

Referring again to the processing system 106 (FIG. 1), it is noted that the processing system 106 may be implemented using hardware or software and may comprise a general or special purpose signal generation and data processing system. In some cases, the processing system 106 may comprise (or implement) a control system 114 that is configured to apply appropriate control signals (e.g., voltages) to the modulated polarizer 102. In other cases, and as shown in FIG. 7, a polarimeter 700 may comprise a separate control system 708 for applying control signals to the modulated polarizer 102. Operation of the control system 708 may or may not be controlled by the processing system 706. Alternately (not shown), the control system 708 could be incorporated into the modulated polarizer 702.

FIG. 7 illustrates various other modifications and additions that can be made to the polarimeter 100 (FIG. 1). Similarly to the polarimeter 100, the polarimeter 700 shown in FIG. 7 comprises a modulated polarizer 702, a detector 704, and a processing system 706. In general, the components 702, 704, 706 perform functions that are the same or similar to those performed by their corresponding components 102, 104,106 in the polarimeter 100 (FIG. 1).

One exemplary addition to the polarimeter 700 is an optical coupler 710. The optical coupler 710 may include a fiber pigtail 712 for transmitting the optical signal 108 to the modulated polarizer 702. In the same or different embodiments, the optical coupler 710 may be a single mode (SM) optical coupler having an optical input and first and second optical outputs, wherein the optical input is configured to receive the optical signal 108, wherein the first optical output is configured to transmit a portion of the optical signal to the modulated polarizer 102, and wherein the second optical output is configured to transmit a portion of the optical signal to a second detector 714. If a known fraction of the optical signal is transmitted to the second detector 714, the second detector 714 may generate a signal on line 716 that is related to the intensity of the optical signal 108, thereby eliminating the need for the processing system 706 to determine the intensity of the optical signal 108 from the DC component of the signal it receives from the detector 704. The fraction of optical power diverted to the second detector 714 may be factored into the calculations of the processing system 706.

As also shown in FIG. 7, the polarimeter 700 may comprise an optional intensity modulator 718, coupled between the modulated polarizer 702 and the detector 704. The intensity modulator 718 may be configured to modulate the intensity of the optical signal transmitted by the modulated polarizer 702, at an intensity modulation frequency fₘ. When the intensity modulator 718 is used, the processing system 706 may comprise a synchronous detection function that improves detection of low power signals. The intensity modulation frequency should be higher than the modulation frequency of the modulated polarizer 702. The synchronous detection function may be synchronized with the intensity modulation frequency fₘ, or with a lower intermediate frequency that is mixed down from the intensity modulation frequency fₘ.

In the above-described polarimeter embodiments 100, 700 (FIGS. 1 & 7), the designer determines the desired modulation of the modulated polarizer and generates the necessary control signals (e.g., potentials) for the modulated polarizer 102 from a calibration model for the modulated polarizer 102. Alternatively a known trajectory, such as that which is described by Eq. (2), can be used. The trajectory described by Eq. (2) produces exactly three frequencies.

Refer now to FIGS. 8 and 9, which illustrate the modulated polarizer trajectory described by Eq. (2). FIG. 8 shows the trajectory on the Poincare sphere, and FIG. 9 is a graph of the trajectory's polarization components (q(t), u(t), v(t)). Referring to FIG. 8, trajectory 800 is topologically a figure eight, having two loops that are joined at the two points shown at 802 and 804.

The choice of modulated polarizer trajectory, from among those trajectories that generate modulation matrices having non-zero determinants (see Eq. (11)), can be guided by some general principles that are listed below. Trajectories that generate fewer frequencies for all polarization components q(t), u(t) and v(t) of the modulated polarizer 102 are preferred; however, at least three harmonics are required. Only three harmonics are needed to solve for the polarization state (x, y, z). The additional harmonics divert energy that would have gone into the harmonics that are being used; hence, trajectories that generate a significant number of additional harmonics are likely to lead to lower signal-to-noise ratios.

The number of harmonics that are generated by any given trajectory may depend on the number of harmonics in the corresponding voltages that are applied to the electrodes of the modulated polarizer 102. Also, complicated voltage waveforms are more difficult to synthesize, and hence, can lead to more complex driving circuitry for the modulated polarizer 102.

There is also a limit on the voltages that can be generated by the control system 114 and applied to the modulated polarizer 102. Hence, a trajectory on the Poincare sphere must be traversable using voltages that are within some predetermined range of voltages.

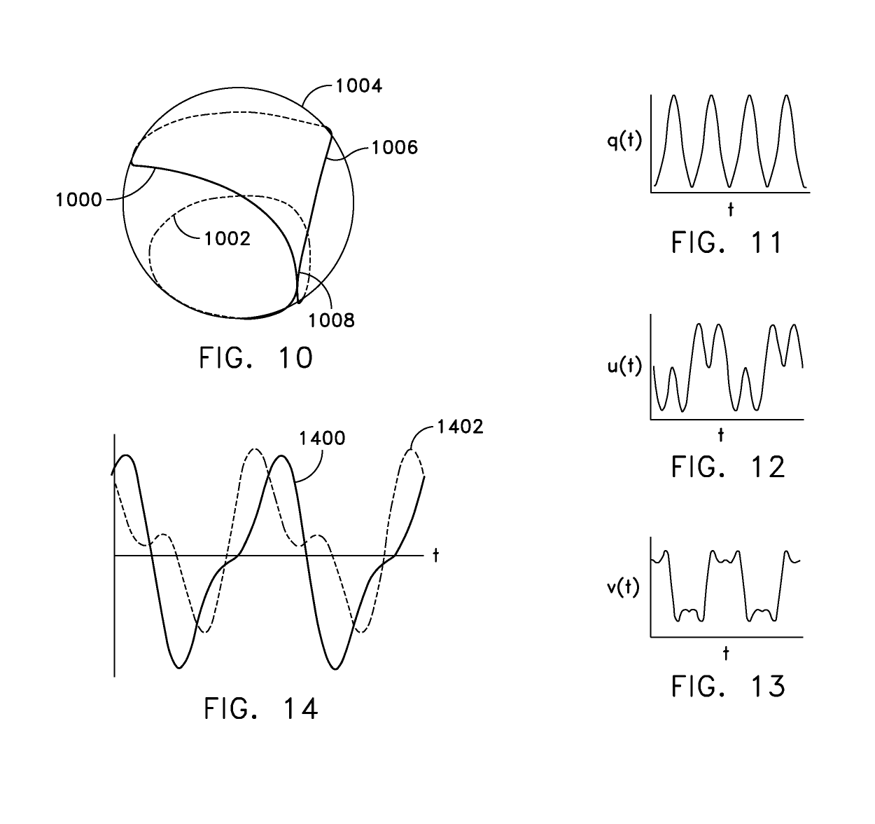

Refer now to FIGS. 10-13, which illustrate an exemplary trajectory that may be utilized in some embodiments of the polarimeter 100 or 700 (FIG. 1 or 7). FIG. 10 is a perspective view of Poincare sphere 1004. FIGS. 11-13 illustrate the polarizer state components of the modulated polarizer 102 when traversing trajectory 1006. Trajectory 1006 is topologically a figure eight, having a first loop 1000 in the northern hemisphere of Poincare sphere 1004 and a second loop 1002 in the southern hemisphere of Poincare sphere 1004. The loops 1000, 1002 meet at point 1008 on the equator. Both loops 1000, 1002 are traversed clockwise as viewed by an observer located on the outside of the sphere 1004. The direction of the rotation is important to maintain a non-zero determinant of the modulation matrix.

The modulation of the components q(t), u(t) and v(t) of the modulated polarizer 102 (FIG. 1) are shown in FIGS. 11-13. As noted above, at least some of the components of the modulated polarizer 102 include harmonics that can be used to solve for the polarization state parameters x, y and z.

Refer now to FIG. 14, which illustrates the voltage waveforms 1400 and 1402 that are applied to electrodes 508 and 510 (FIGS. 5 and 6), and which cause the modulated polarizer 102 to move about trajectory 1006. Voltage waveforms 1400 and 1402 contain two cycles and correspond to two evolutions along the trajectory 1006. The reference electrode 812 is held at ground in this embodiment.

The above-described trajectories on the Poincare sphere are closed loops, and hence, the modulation frequencies are harmonics of the frequency with which the closed loop is traversed. For the purposes of the present discussion, a path will be defined as being closed if it begins and ends at the same point on the Poincare sphere. This will always be the case when polarizer modulation is performed in accord with a periodic function. In some cases, it may be advantageous to use modulation frequencies that are unrelated frequencies instead of harmonics. For example, such unrelated frequencies could reduce some errors caused by harmonics produced by non-linearities of the detector 104 (FIG. 1). Trajectories in which the polarization components are modulated in a periodic manner without requiring the trajectory to be closed are possible. An example of such a trajectory is given by

q(t)=cos(2ω₁t)

u(t)=(sin(2ω₁t−ω₂t)+sin(2ω₁t+ω₂t))/2

v(t)=(cos(2ω₁t−ω₂t)+cos(2ω₁t+ω₂t))/2 (15)

where ω₁=eω/2 and ω₂=ω. Here e is the irrational number, 2.71828 . . . . The processing system 106 (FIG. 1) detects modulation at (e−1)ω, eω, and (e+1)ω, where ω is chosen to provide detection at frequencies that are within the range of the detector 104. It should be noted that while polarizer modulation is described by periodic functions, the trajectory defined by Eq. (15) is not periodic. The trajectory is endless and eventually samples the entire Poincare sphere surface without repeating itself.

What is claimed is:

1. A polarimeter, comprising:
a modulated polarizer, modulated at a modulation frequency and configured to transmit a portion of an optical signal based on its modulation;
a detector configured to generate a time-varying output signal related to a time-varying power of the transmitted portion of the optical signal; and
a processing system configured to i) detect at least three frequency components of the time-varying output signal, and ii) determine the polarization state of the optical signal based on the at least three frequency components.

2. The polarimeter of claim 1, wherein the processing system is further configured to determine the intensity of the optical signal.

3. The polarimeter of claim 2, wherein the processing system is further configured to determine, from the polarization state of the optical signal and the intensity of the optical signal, a degree of polarization of the optical signal.

4. The polarimeter of claim 2, wherein the processing system is configured to determine the intensity of the optical signal from a DC component of the time-varying output signal generated by the detector.

5. The polarimeter of claim 1, further comprising:
a second detector, configured to generate a signal related to the intensity of the optical signal;
wherein the processing system is configured to determine the intensity of the optical signal from the signal generated by the second detector.

6. The polarimeter of claim 5, further comprising:
an optical coupler having an optical input and first and second optical outputs, wherein the optical input is configured to receive the optical signal, wherein the first optical output is configured to transmit the optical signal to the modulated polarizer, and wherein the second optical output is configured to transmit the optical signal to the second detector.

7. The polarimeter of claim 1, wherein the modulated polarizer comprises:
a polarization controller; and
a polarizer, optically downstream from the polarization controller and having a fixed orientation with respect to the polarization controller.

8. The polarimeter of claim 7, wherein the polarization controller comprises an x-cut, z-propagating, lithium niobate (LiNbO₃) crystal having a plurality of electrodes on a surface thereof, and wherein the modulation frequency is defined by a plurality of control signals applied to the plurality of electrodes.

9. The polarimeter of claim 8, further comprising a control system configured to apply the plurality of control signals to the plurality of electrodes.

10. The polarimeter of claim 9, wherein the control system is part of the processing system.

11. The polarimeter of claim 1, wherein the state of the modulated polarizer traces a closed loop on a Poincare sphere.

12. The polarimeter of claim 1, wherein the state of the modulated polarizer traces an open path on a Poincare sphere.

13. The polarimeter of claim 1, further comprising:
an intensity modulator coupled between the modulated polarizer and the detector, the intensity modulator modulating an intensity of the transmitted portion of the optical signal at an intensity modulation frequency;
wherein the processing system performs a synchronous detection.

14. The polarimeter of claim 13, wherein the synchronous detection function is synchronized with the intensity modulation frequency.

15. The polarimeter of claim 13, wherein the synchronous detection function is synchronized with an intermediate frequency, and wherein the intermediate frequency is mixed down from the intensity modulation frequency.

16. The polarimeter of claim 1, further comprising an optical coupler, wherein the modulated polarizer receives the optical signal via the optical coupler.

17. A method for determining the polarization state of an optical signal, comprising:
modulating a state of a modulated polarizer, at a modulation frequency, to alter a portion of the optical signal that is transmitted through the modulated polarizer;
generating a time-varying output signal related to a time-varying power of the transmitted portion of the optical signal;
detecting at least three frequency components of the time-varying output signal; and
determining the polarization state of the optical signal based on the at least three frequency components.

18. The method of claim 17, further comprising, determining the intensity of the optical signal.

19. The method of claim 18, further comprising, determining from the polarization state of the optical signal and the intensity of the optical signal, a degree of polarization of the optical signal.

20. The method of claim 18, wherein the intensity of the optical signal is determined from a DC component of the time-varying output signal.
